(19) United States
(12) Patent Application Publication
(10) Pub. No.: US 2010/0045019 A1
(43) Pub. Date: Feb. 25, 2010

(54) VEHICLE FRAME FOR LIQUID CONTAINER SUPPORT

(76) Inventor: Kurtis Bear, La Crescent, MN (US)

Correspondence Address: Clise, Billion & Cyr, 605 US Hwy 169 North, Suite 300, Plymouth, MN, 55441, US

(21) Appl. No.: 12/398,662

(22) Filed: Mar. 5, 2009

Related U.S. Application Data
(60) Provisional application No. 61/091,544, filed on Aug. 25, 2008.

(51) Int. Cl. B60P 3/22

(52) U.S. Cl. 280/838

(57) ABSTRACT

This document discusses, among other things, a vehicle frame for a liquid container including one or more longitudinal rails and one or more transverse supports connected to the longitudinal rail, the transverse support including a central portion to be positioned beneath a container for support of the container, the central portion including a plurality of apertures In an example, wherein the central portion includes a top portion, a bottom portion, and one or more webs extending from the top portion to the bottom portion with the web extending generally along a radial line from at least one of a geometric center line of the container or the centerline that corresponds to a center of gravity of the container, or both.

This application claims priority of U.S. Provisional Patent Application Ser. No. 61/091,544, filed Aug. 25, 2008, which is incorporated by reference for any purpose.

### TECHNICAL FIELD

This document pertains generally to vehicle frames, and more particularly, but not by way of limitation, to vehicle frames to support containers for hauling liquids and/or bulk materials.

### BACKGROUND

Rising fuel costs and roadway load restrictions have inspired the present inventors to investigate way to reduce vehicle weight. This is particularly important for trucks that routinely haul heavy loads, such as liquids, between numerous sites over public roadways. For example, milk tucks, such as trailer tank truck, haul milk from multiple farms to one or more dairies.

### OVERVIEW

A vehicle frame for a liquid container is described herein. The container can hold 10,000 gallons or more. In an example, the frame include one or more longitudinal members; and one or more transverse supports connected to the longitudinal member, the transverse support including a central portion to be positioned beneath a container for support of the container, the central portion including a plurality of apertures.

In a second example, which can include the first example, the central portion of the transverse support includes a top portion, a bottom portion, and one or more webs extending from the top portion to the bottom portion with the web extending along a radial line from at least one of a geometric center line of the container or the centerline that corresponds to a center of gravity of the container, or both.

In a third example, which can include the first or second example, the top portion of the transverse support is continuous and is curved to essentially match an outer surface of the container. In a fourth example, which can include any of the first through third examples, the bottom surface of the transverse support is continuous.

In a fifth example, which can include any of the first through fourth examples, the central portion of the transverse includes a slot that match a slot in the longitudinal member to join the transverse support to the longitudinal member. The slot includes a narrow recess inwardly of a wider recess.

In a sixth example, which can include any of the first through fifth examples, the central portion includes a unitary body.

In a seventh example, which can include any of the first through sixth examples, the middle of the transverse support central portion is free of apertures.

In a eighth example, which can include any of the first through seventh examples, the apertures are substantially polygonal in shape.

In a ninth example, which can include any of the first through eighth examples, the transverse support includes a side portion extending outwardly from an end of the central portion, the side portion including apertures therein.

In a tenth example, which can include any of the first through ninth examples, the transverse support side portion extends outwardly from the container.

In a eleventh example, which can include any of the first through tenth examples, the transverse support central portion includes an insulation layer on which the container rests. The insulation layer can be in direct contact with a band on the container.

In a twelfth eleventh example, which can include any of the first through eleventh examples, the transverse support central portion includes a cushioning gasket on which the container rests.

In a 13th example, which can include any of the first through twelfth examples, the transverse support side portion includes a horizontal top surface to support a walkway.

In a 14th example, which can include any of the first through 13th examples, the transverse support includes a machined unitary body of a nonferrous metal. In an example, the non-ferrous metal is aluminum. In an example, the non-ferrous metal is aluminum ASTM 6061. In an example, the non-ferrous metal is stainless steel.

In a 15th example, which can include any of the first through 14th examples, the transverse support is made of a metal having density of less than about 0.1 lb/in³.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a view of a vehicle according to an example of the present invention;

FIG. 2 is a top view of a tanker according to an example of the present invention;

FIG. 3 is a perspective top, front, left perspective view of a vehicle frame according to an example of the present invention;

FIG. 4 is a rear elevational view of a vehicle frame according to an example of the present invention;

FIG. 5A is an elevational view of transverse support for a vehicle frame according to an example of the present invention:

FIG. 5B shows a view similar to FIG. 5A and showing the alignment of certain webs in the support relative to the center line of a container;

FIG. 6 is an enlarged, partial view of transverse support of FIG. 5A taken at reference 6;

FIG. 7A shows a side view of an example of a longitudinal rail;

FIG. 7B shows an enlarged partial view of an example of the longitudinal rail;

FIG. 7C shows an enlarged partial view of an example of the longitudinal rail;

FIG. 8 shows a rear perspective view of an example of the frame;

FIG. 9 shows an bottom, side view of an example of the tanker; and

FIG. 10 shows an end view of an example of the longitudinal transverse support.

FIG. 11 shows a rear view of the support and a tank thereon.

### DETAILED DESCRIPTION

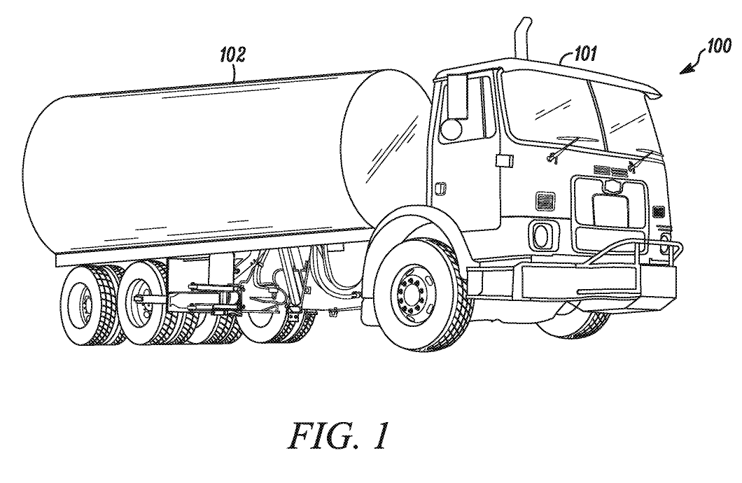

FIG. 1 shows a vehicle 100 including a truck 101 and a tanker 102 connected to the truck 101. Truck 101 includes the motor and other motive component such as transmission and steering. While shown as a separable, the truck 101 and tanker 102 can be fixed together. The tanker 102 includes a frame 105 supporting a liquid container 106. A liquid container 106 when used for milk hauling is sometimes referred to as a bottle. A liquid container 106 can hold 4700 gallons or more. Some containers 106 can hold 10,000 gallons or more. The vehicle 100 can be used to over the road to diary farms to retrieve milk from a farm bulk tank, i.e., a stationary storage tank used only for the holding and cooling of milk. In such a case the vehicle 100 could be considered a milk tank truck. The vehicle 100 may visit a plurality of dairy farms to haul milk to one or more pasteurization plants or other milk processing locations. The vehicle 100 can also haul milk from one plant to another plant. The remote locations of diary farms requires the vehicle to travel significant distances over public roadways to transport milk. Public roadways can have weight restrictions that limit the amount of milk that can be transported as the weight of the vehicle is essentially fixed. The cost of fuel also contributes to the economics of transportation using vehicle 100. If the vehicle can be made lighter, then the vehicle can carry more weight in its tanker 102 and remain below the weight restrictions. A lighter vehicle would also consume less fuel when carrying an equivalent weight in product.

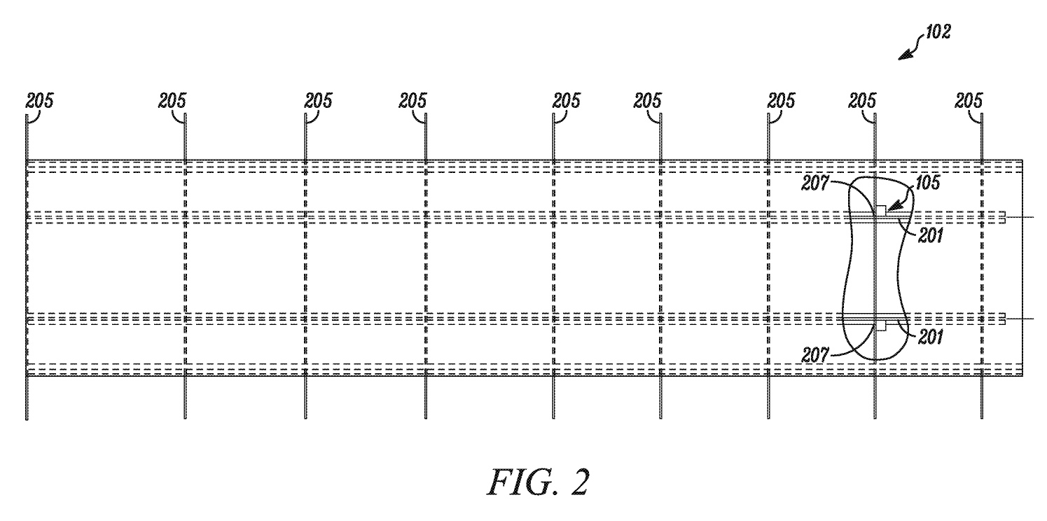

FIG. 2 is a top view of the tanker 102 that includes at least one longitudinal rail 201 to which are fixed a plurality of transverse supports 205 at joints 207. The transverse supports 205 support the liquid container. As shown, two parallel longitudinal rails 201 are fixed at joints 207 to nine transverse supports 205. The transverse supports 205 are spaced between two and three feet apart. The transverse supports 205 can include cut outs as will be explained further to reduce weight of the tanker.

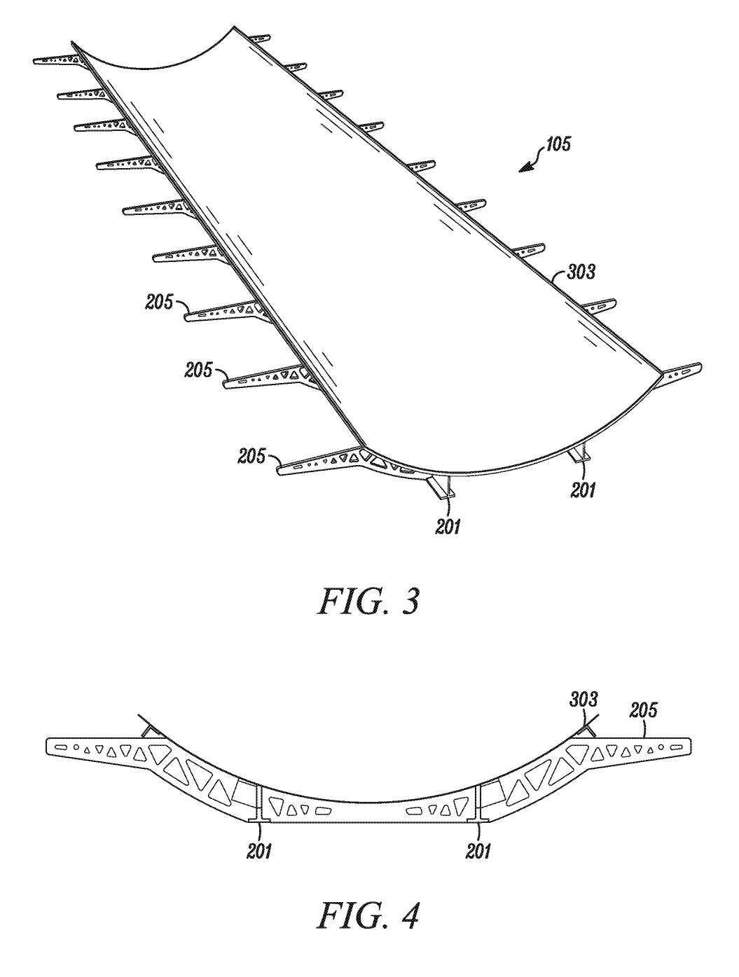

FIG. 3 is a schematic, perspective view of an example of a frame 105 that includes two longitudinal rails 201 and a plurality of transverse supports 205. The longitudinal rails 201 have an upside down T-shape with the body of the T in engagement with the transverse supports 205 and the cross-piece of the T provided for structural support of the rail. In an example, described below in greater detail, the cross piece of the T shape is also in contact with the transverse support. The transverse supports 205 include a plurality of cut outs and hence have a web like structure. The transverse supports 205 support a cradle 303 that in turn support a liquid container (not shown in FIG. 3).

FIG. 4 is a rear elevational view of the FIG. 3 example of a frame 105. The longitudinal rails 201 support the transverse support 205 that in turn supports the cradle 303. It will be within the scope of the present invention to support a liquid container without a cradle (e.g., 303). In this example, the liquid container will reside on the transverse supports 205. The transverse supports 205 can further include a cushioning gasket and an insulator layer intermediate the liquid container and the body of the transverse support 205. This is particularly useful when the liquid container is a milk hauling bottle.

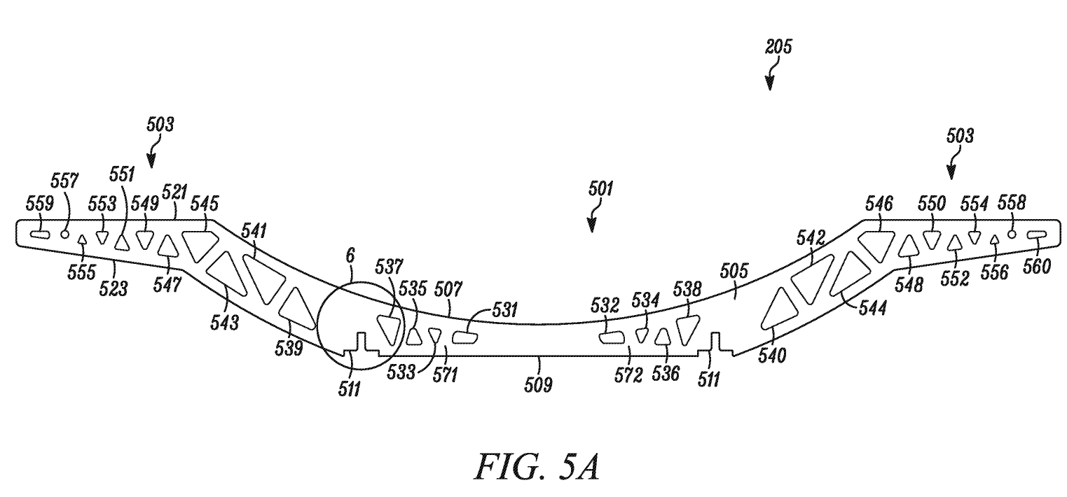

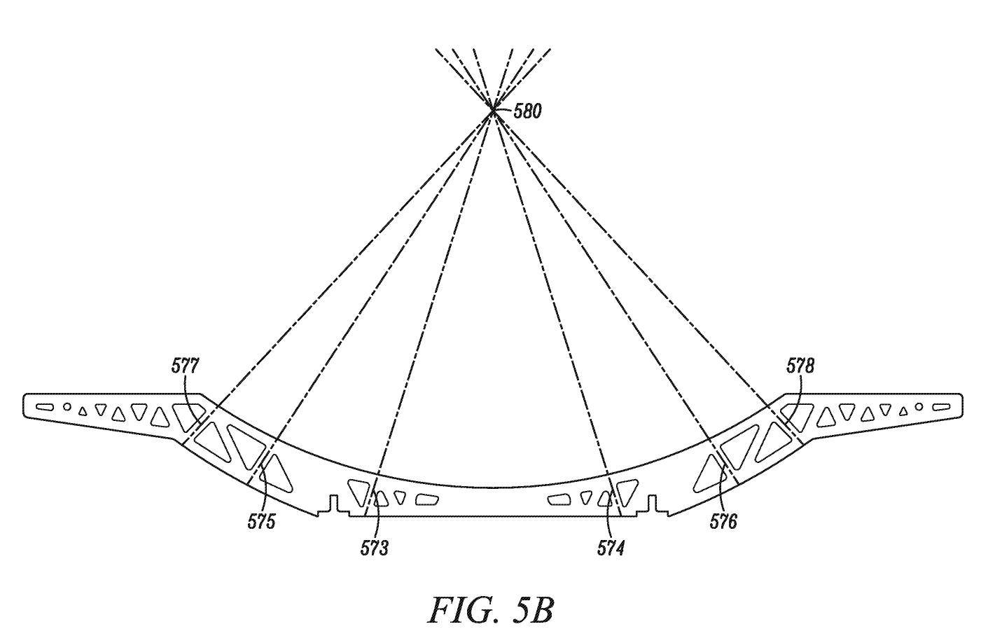

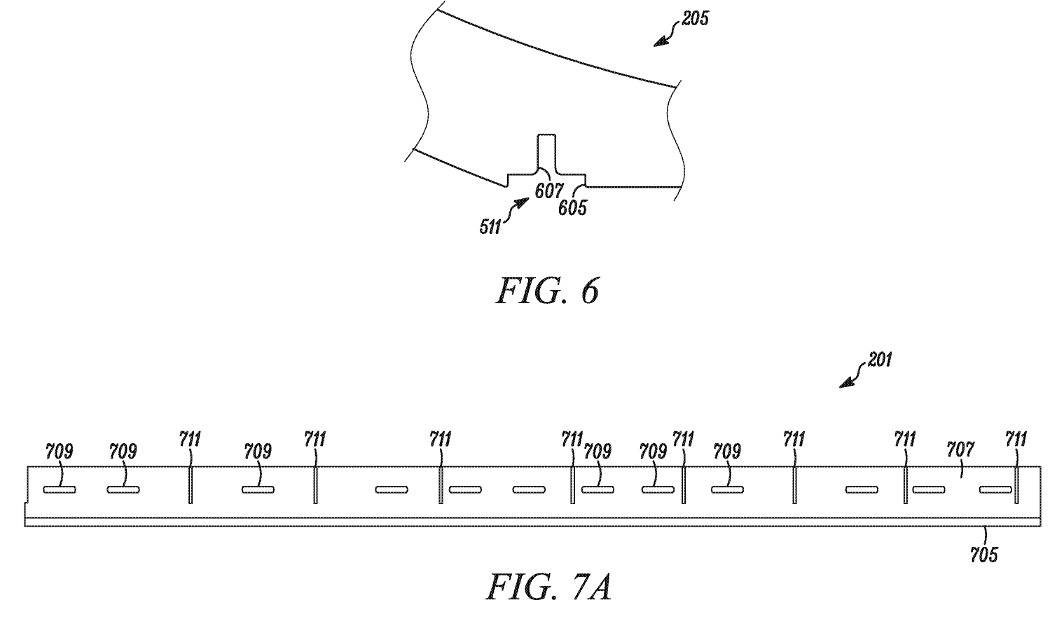

FIG. 5A shows a front elevational view (enlarged relative to other views to show details) of the transverse support 205 with a central portion 501 from the ends of which are cantilevered two wing portions 503, respectively. The center portion 501 includes a unitary body 505 that defines a top surface 507, on which a container is supported and a bottom surface 509. The terms “top” and “bottom” refer to the respective positions in the final assembly of frame. Body 505 is free of cutouts or apertures extending therethrough. The top surface 507 is curved throughout its length to essentially match a curved, outer surface of the liquid container. In an example, the top surface is normal to the radius of the liquid container along the arc thereof that is directly supported by the top surface 507. The top surface 507 is continuous such that is supports the liquid container along the entire length of the transverse support center portion 501. In an example, the top surface 507 has a width of 0.5 inch, or greater. While not shown in FIG. 5, top surface 507 can include an insulating layer, a cushioning gasket, or both, depending on the type of liquid container. The bottom surface 509 has a flat center portion intermediate slots 511 that form connections to the frame rails. The slots 511 will be explained in greater detail with regard to FIG. 6 below. At or adjacent the recesses 511, the bottom surface 509 transitions to upwardly curve to essentially follow the shape of the liquid container. The upward curve of the bottom surface 509 can begin at the outward edge of the respective recess 511. The bottom surface 509 and the top surface 507 can be parallel at the outer parts of the transverse support center portion 501. At the narrowest point in the transverse support central portion 501, the top surface 507 and bottom surface 509 are between 2.5 inches and 3.0 inches apart. In an example, either limit of this range or the separation height is 2 11/16 inches. The flat portion of the bottom surface can have a length of about 2.5 feet to about 3 feet. In an example, either limit of this range or the length can equal 2 feet, seven inches. It will be recognized that the dimensions of the center portion 501 can be changed to match the container it supports.

The side wings 503 extend from opposite, respective ends of the central portion 501. In an example, the side wings and central portion are formed from a unitary, single piece of material. The material in an example is a lightweight non-ferrous material such as aluminum. The side wings 503 include a top surface 521 and a bottom surface 523. The top surface 521 joins to the central portion top surface 507 to form a continuous surface. The top surface 521 extends horizontally and is adapted to support a platform that runs alongside the liquid container as may be further described herein. The bottom surface 523 slopes upwardly from inside to outside relative to the transverse support as a whole. Accordingly, the side wings 503 require less material at the outward ends. The side wings 503 further include a more than one cutouts or apertures therein to reduce the amount of material and hence, weight. Like the central portion 501, the side wings 503 have a width of about 0.5 inch. In an example, the width is greater than 0.5 inch. The side wings have the same width as the central portion. The height from the lowest point of the central portion top surface 507 and the side wing top surface is about 9½ inches plus or minus ⅛ inch. The length of the side wing depends on the width of the desired platform it is to support. In an example, the entire length of the transverse support, including two side wings 503 and the central portion 501 is about seven and ⅔ feet. It will be recognized that the side wings 503 can be altered to provide the type of support needed adjacent the container. In an example, only one side wing is provided.

The transverse support 206 includes a plurality of apertures 531-560, with the odd reference numbers representing apertures on the left side of FIG. 5 and the even reference numbers representing apertures on the right side of FIG. 5. It will further be appreciated that each odd/even pair of reference numbers designate a same-shaped aperture but on opposite sides of the transverse support 205 in this example. Moreover, these paired apertures (531 and 532, 533 and 534, 535 and 536, 537 and 538, 539 and 540, 541 and 542, 543 and 544, 545 and 546, 547 and 548, 549 and 550, 551 and 552, 553 and 554, 555 and 556, 557 and 558, and 559 and 560) are symmetrical about the vertical center line of the transverse support 205.

As shown the transverse support 205 is symmetrical about its vertical geometric center line. However, it is within the scope of the present disclosure to create a transverse support that is not symmetrical. In an example, one of the side wings 503 is not formed. In an example, cutouts can be added on one side and not the other to accommodate requirements of the truck or liquid container. For example, control systems, brake systems, cooling systems, etc. can require specific cutouts or alterations in the transverse support.

The apertures 531-560 have a generally polygon shape with straight sides, however, the corners may be rounded and not a point of intersection of the respective sides. Many of the apertures have a three sides. Other apertures have four sides. It will further be appreciated that some of the apertures 531-560 include at least one side that runs parallel to a radial line extending from the geometric center line of the container and normal to the outer surface of the container. Thus, two adjacent apertures define a web of solid material in the transverse support 205 that extends from the bottom surface 509 to the top surface 507. For example, adjacent apertures 531 and 533 define a web 571 therebetween. Adjacent apertures 532 and 534 define a web 572 therebetween.

Some webs are aligned with and, in an example, co-linear with a radial line of the container, for example, webs 573-578 (FIG. 5B). Other webs may also be positioned this way. It will be appreciated that some containers may not be perfectly cylindrical. Accordingly, a radial line in this instance will extend from a geometric center line to the outer surface of the container and intersect the outer surface generally normal thereto. Webs 571 and 572 are the closest to vertical of any web along the container radial line as they are closest to the center of the transverse support 205. As stated herein the center portion 509 of the support 205 is free of apertures such that the support provides adequate strength to support the container, even when full. Other positions for webs that are positioned on the radial line are also between pairs of apertures 535 and 537, 536 and 538, 539 and 541, 540 and 542, 543 and 545, 544 and 546, 547 and 549, 548 and 550, 551 and 553, 552 and 554, 555 and 557, and 556 and 558. Webs between the other adjacent pairs of apertures extend in a direction other than along the container radial line. The position of these webs add to the structural stability of the support 205 and can prevent twisting of the support. Some of these non-aligned webs extend from the bottom of one aligned web to the top of another aligned web.

FIG. 5B shows the alignment of the aligned webs relative to the center line 580 of the container to be supported on the support 205. The centerline 580 would extend into and out of the paper as show in FIG. 5B. As illustrated each of the webs 573-578 is positioned essentially co-linear with a line extending from the container centerline 580. In some examples, the webs may be a few degrees off exact alignment with these radial lines and still provide adequate structural support.

FIG. 6 shows a partial side view of a transverse support 205. The slot 511 extends upwardly into the body of support 205. Slot 511 includes a wide first portion 605 that opens downwardly of the support 205. Slot 511 includes a narrower second portion 607 that extends from the first portion 608 upwardly into the support. The first portion 605 is adapted to receive a horizontal stabilizing portion of the rail 201. The second portion 607 is adapted to receive a vertical stabilizing portion of the rail 201. The slot(s) 511 further reduces the mass and weight of the support 205.

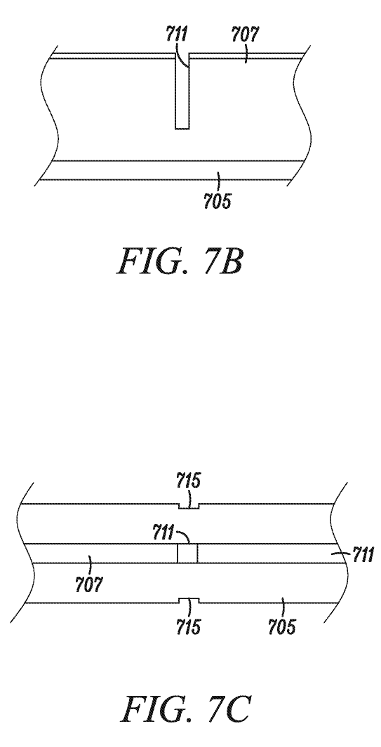

FIG. 7A shows a side view of an example of the longitudinal rail 201 that includes a horizontal stabilizing portion 705 and a vertical stabilizing portion 707, each being elongate. The portion 705 has a greater dimension in the horizontal dimension than in its vertical dimension. The portion 707 has a greater dimension in the vertical dimension than in its horizontal dimension. Vertical stabilizing rail 707 includes a plurality of apertures 709 intermediate rail slots 711. The apertures 709 further reduce the mass and weight of the frame. The slots 711 are positioned where the transverse supports 205 are to be positioned along the length of the rail 201 with the supports 205 matingly receiving the rail. The rail slot 711 being positioned upwardly of the support slot 511 along each side of the transverse support 205. The vertical stabilizing portion 707 of the rail immediately downwardly of the slot 711 is received in the portion 607 of the support slot 511. The horizontal stabilizing portion 705 is received in the portion 605 of the support slot 511. This provides repeatable and stable fabrication.

FIG. 7B shows an enlarged partial view of an example of the longitudinal rail 201 including the recess 711 in the vertical stabilizing portion 707 that in turn extends upwardly of the horizontal stabilizing portion 705.

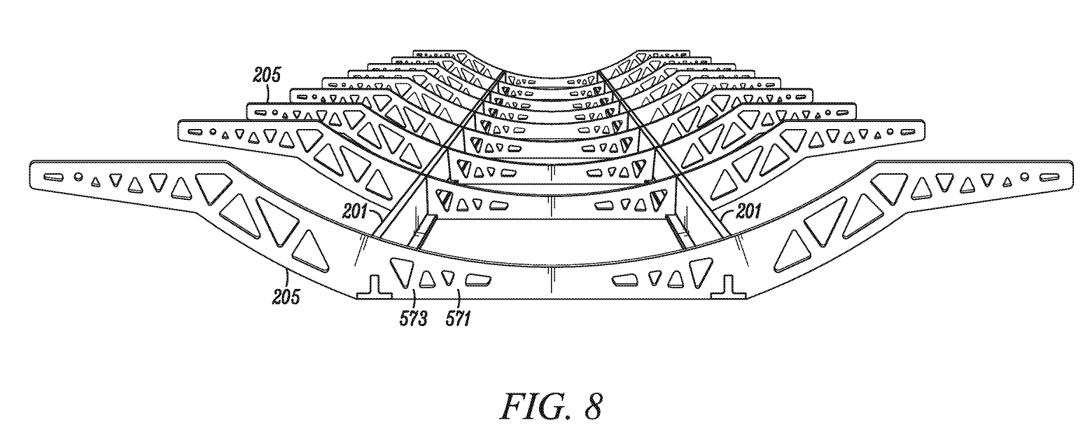

FIG. 7C shows an enlarged partial view of an example of the longitudinal rail 201. including the recess 711 in the vertical stabilizing portion 707 that in turn extends upwardly of the horizontal stabilizing portion 705. In this example, recesses 715 are positioned in the horizontal stabilizing portion 705. Recesses 715 are aligned with the slot 711 such that portion 605 of the transverse support slot 511 can be made slightly smaller than the width of the horizontal stabilizing portion 705. Accordingly, the recesses 511, 711 can provide a more precise alignment of the transverse supports on the rail to ease fabrication and provide a more precise alignment for welding. Moreover, the top surface of the rail 201 can provide a further direct support to the length of the container as can more clearly be seen in FIG. 8

FIG. 8 shows a rear perspective view of an example of the frame 105 including a plurality of transverse supports 205 fixed two, spaced apart rails 201.

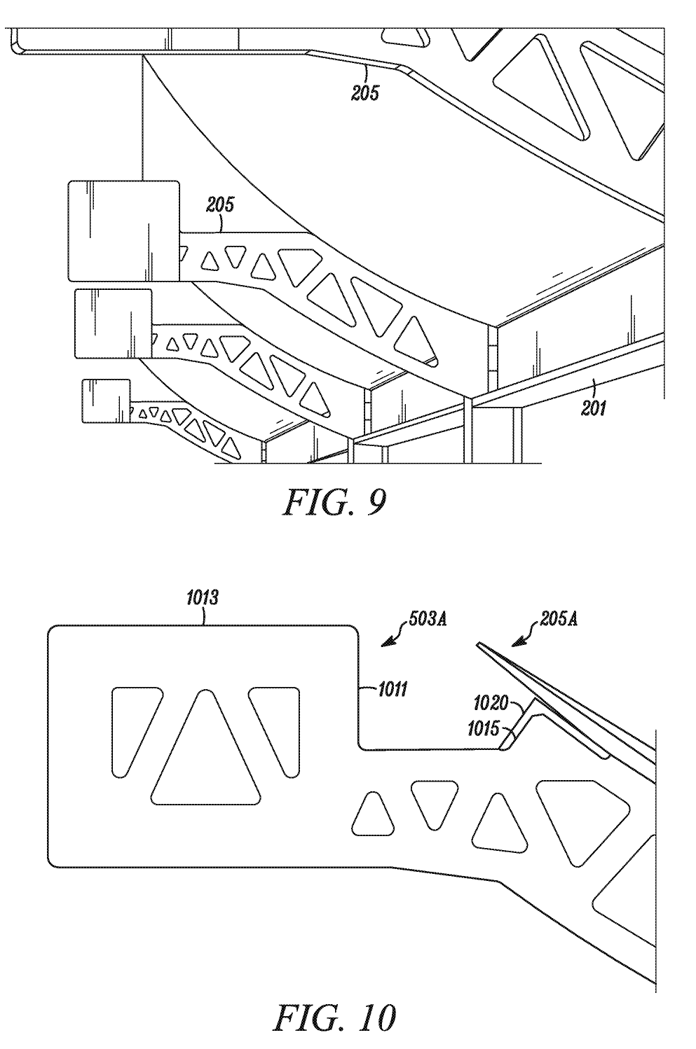

FIG. 9 shows an bottom, side view of an example of the tanker 102 including a rail 201 and transverse supports 205 that support a container. A walkway is fixed to the end of the transverse supports 205.

The transverse support 205 as described herein can be machined from a unitary body of a nonferrous metal. In an example, the nonferrous metal is aluminum. In an example, the non-ferrous metal is aluminum ASTM 6061. In an example, the non-ferrous metal is stainless steel. The longitudinal rail 201 can be of the same material as the transverse support. In an example, the material for either or both of the longitudinal rail 201 and transverse support 205 is a metal having density of less than about 0.1 lb/in³.

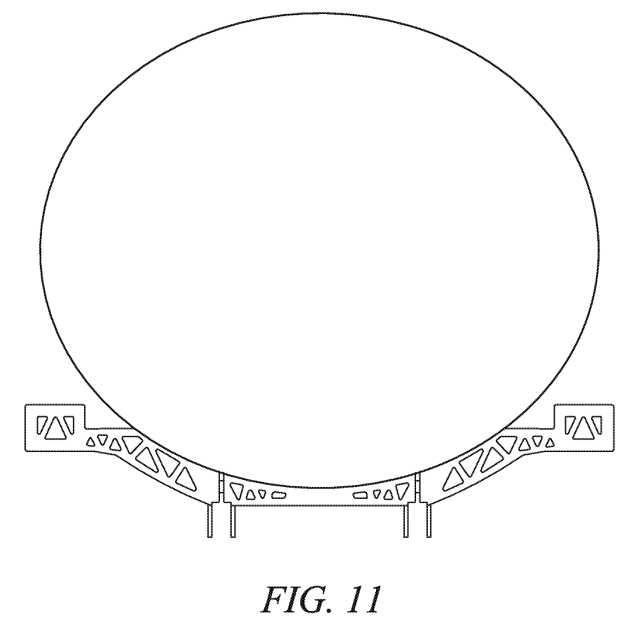

FIG. 10 shows an embodiment of an end 503A of the traverse support 205A. Numbering for this embodiment is adopts the same reference number as used herein for similar elements with the addition of the suffix “A” for clarity. The end 503A includes an upwardly open recess 1011 having a vertical edge and a horizontal edge. Recess 1011 further reduces the weight of the transverse support 503A without degrading the integrity of the support 205A. Transverse support end 503A includes a horizontal, flat top portion 1013 that supports a walkway that will be adjacent to a tank being supported on transverse support 205A. The transverse support end 503A further includes a plurality of cutouts and webs, vertical and offset, as discussed herein. Transverse support end 503A further includes an inset 1015 that extends along the inward side of the recess 1011 forming an oblique angle with the horizontal edge of the recess 1011. The inset 1015 then continues over a corner along the upper, curved surface of the 507A of the transverse support 205A. The inset extends a few inches along the surface 507A, here, about half way along the width of the first adjacent cutout. The inset 1015 ends before the first web. A cap 1020 is positioned in the inset 1015 to support and directly contact a tank or a cradle that is to be supported on the transverse support 205A.

The examples of the present invention described herein provide for a reduced weight and mass frame by positioning apertures in transverse supports. These apertures can reduce the weight of a solid body support 10% or more. In some examples the weight can be reduced up to 25%. Even greater weight reductions can be achieved when using material having less weight than iron or some types of steel. The design and positioning of the apertures allows the support to provide the mechanical stability and ability to adequately support the container.

The embodiments described herein related to containers for liquids. It will be appreciated that some embodiments can be adapted to provide supports for other vehicle frames.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A vehicle frame for a liquid container, comprising:
one or more longitudinal rails; and
one or more transverse supports connected to the longitudinal rail, the transverse support including a central portion to be positioned beneath a container for support of the container, the central portion including a plurality of apertures.

2. The vehicle frame of claim 1, wherein the central portion includes a top portion, a bottom portion, and one or more webs extending from the top portion to the bottom portion with the web extending generally along a radial line from at least one of a geometric center line of the container or the centerline that corresponds to a center of gravity of the container, or both.

3. The vehicle frame of claim 2, wherein the top portion is continuous and is curved to essentially match an outer surface of the container.

4. The vehicle frame of claim 3, wherein the bottom surface is continuous.

5. The vehicle frame of claim 1, wherein the central portion includes a slot that match a slot in the longitudinal rail to join the transverse support to the longitudinal rail.

6. The vehicle frame of claim 5, wherein the slot of the central portion includes a narrow recess inwardly of a wider recess.

7. The vehicle frame of claim 1, wherein the central portion includes a unitary body.

8. The vehicle frame of claim 1, wherein the middle of the central portion being free of apertures.

9. The vehicle frame of claim 8, wherein the apertures are substantially polygonal in shape.

10. The vehicle frame of claim 1, wherein the transverse support includes a side portion extending outwardly from an end of the central portion, the side portion including one or more apertures therein.

11. The vehicle frame of claim 10, wherein the side portion extends outwardly from the container.

12. The vehicle frame of claim 11, wherein the side portion including a horizontal top surface to support a walkway.

13. The vehicle frame of claim 1, wherein the central portion includes an insulation layer and a cushioning gasket on which the container rests.

14. The vehicle frame of claim 13, wherein the insulation layer is in direct contact with a band on the container.

15. The vehicle frame of claim 1, wherein the transverse support includes a machined unitary body of a non-ferrous metal.

16. The vehicle frame of claim 15, wherein the non-ferrous metal is aluminum.

17. The vehicle frame of claim 15, wherein the non-ferrous metal is aluminum ASTM 6061.

18. The vehicle frame of claim 15, wherein the non-ferrous metal is stainless steel.

19. The vehicle frame of claim 1, wherein the transverse support is made of a metal having density of less than about 0.1 lb/in³.

20. The vehicle frame of claim 1, wherein the transverse support includes an inset at an end thereof, and a cap positioned in the inset.
